(19) United States
(12) Patent Application Publication
(10) Pub. No.: US 2026/0063806 A1
(43) Pub. Date: Mar. 5, 2026

(54) GLOBAL NAVIGATION SATELLITE SYSTEM RECEIVER WITH HARDWARE SHARING ACHIEVED THROUGH HYPOTHESIS SCHEDULING MACHINE AND ASSOCIATED METHOD

(71) Applicant: Airoha Technology Corp., Hsinchu City (TW)

(72) Inventors: Yi-Ting Lee, Hsinchu County (TW); Ching-Yi Huang, Hsinchu County (TW); Ching-Chiao Kuan, Hsinchu County (TW); Chun-Yuan Huang, Hsinchu County (TW); Chia-Lung Wu, Tainan City (TW); Yu-Wei Lee, Hsinchu County (TW); Jeng-Hong Chen, Manhattan Beach, CA (US)

(73) Assignee: Airoha Technology Corp., Hsinchu City (TW)

(21) Appl. No.: 18/822,483

(22) Filed: Sep. 3, 2024

(51) Int. Cl. G01S 19/37; G01S 19/29; G01S 19/30

(52) U.S. Cl. CPC G01S 19/37; G01S 19/29; G01S 19/30

(57) ABSTRACT

A global navigation satellite system (GNSS) receiver includes a multiplexer circuit, a fast Fourier transform (FFT) circuit, a pre-sampler circuit, a code generator circuit, and a hypothesis scheduling machine (HSM). The multiplexer circuit has a first input port, a second input port, and an output port. The FFT circuit is coupled to the output port. The pre-sampler circuit generates and outputs a data sequence output to the first input port of the multiplexer circuit. The code generator circuit generates and outputs a local replica output to the second input port of the multiplexer circuit. The HSM is coupled to the multiplexer circuit, the pre-sampler circuit, and the code generator circuit. Under coordination of the HSM, the FFT circuit is shared between the pre-sampler circuit and the code generator circuit through the multiplexer circuit.

### BACKGROUND OF THE INVENTION

### 1. Field of the Invention

The present invention relates to a global navigation satellite system (GNSS) receiver design, and more particularly, to a GNSS receiver with hardware sharing achieved through a hypothesis scheduling machine and an associated method.

### 2. Description of the Prior Art

GNSS is often described as an “invisible utility”, and is so effective at delivering two essential services—time and position—accurately, reliably and cheaply that many aspects of the modern world have become dependent upon them. Each satellite of the GNSS is equipped with a highly precise atomic clock. When four or more satellites are in view, a GNSS receiver can measure the distance to each satellite by estimating the signal transmission time delay from the satellite to the receiver. From these measurements, a GNSS-embedded device can derive its own position and synchronize to the accurate GNSS system time.

A GNSS satellite signal is modulated by a pseudo random noise (PRN) code. The PRN code is a code sequence with randomly distributed 0's and 1's. Each satellite transmits a unique PRN code. Hence, the GNSS receiver identifies any of the satellites by its unique PRN code. The unique PRN code is continuously repeated. The GNSS receiver can use a local replica version of the unique PRN code to correlate the received satellite signal for acquisition. More specifically, since GNSS is a spread spectrum communication system, the de-spreading processing of the GNSS receiver is to perform a correlation operation, which is either time-domain correlation or frequency-domain correlation, between the received satellite signal and the local replica. Nowadays, there is an increasing interest for the computation of high complexity GNSS signals with frequency-domain correlation. Thus, there is a need for a GNSS receiver which is capable of directly acquiring high complexity GNSS signals.

### SUMMARY OF THE INVENTION

One of the objectives of the claimed invention is to provide a GNSS receiver with hardware sharing achieved through a hypothesis scheduling machine and an associated method.

According to a first aspect of the present invention, an exemplary GNSS receiver is disclosed. The exemplary GNSS receiver includes a multiplexer circuit, a fast Fourier transform (FFT) circuit, a pre-sampler circuit, a code generator circuit, and a hypothesis scheduling machine (HSM). The multiplexer circuit has a first input port, a second input port, and an output port. The FFT circuit is coupled to the output port. The pre-sampler circuit is arranged to generate and output a data sequence output to the first input port of the multiplexer circuit. The code generator circuit is arranged to generate and output a local replica output to the second input port of the multiplexer circuit. The HSM is coupled to the multiplexer circuit, the pre-sampler circuit, and the code generator circuit. Under coordination of the HSM, the FFT circuit is shared between the pre-sampler circuit and the code generator circuit through the multiplexer circuit.

According to a second aspect of the present invention, an exemplary GNSS receiving method is disclosed. The exemplary GNSS receiving method includes: performing a multiplexing operation upon a data sequence output of a pre-sampling operation and a local replica output of a code generation operation, to generate a multiplexing output; and performing FFT upon the multiplexing output.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a GNSS receiver system-on-chip (SoC) according to an embodiment of the present invention.

FIG. 2 is a diagram illustrating a pre-processor circuit according to an embodiment of the present invention.

FIG. 3 is a diagram illustrating a pre-sampler circuit according to an embodiment of the present invention.

FIG. 4 is a diagram illustrating 4 data interleaving modes according to an embodiment of the present invention.

FIG. 5 is a diagram illustrating a data flow that is based on 4 data interleaving modes according to an embodiment of the present invention.

FIG. 6 is a diagram illustrating real-time signal processing performed at the GNSS receiver SoC shown in FIG. 1 according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

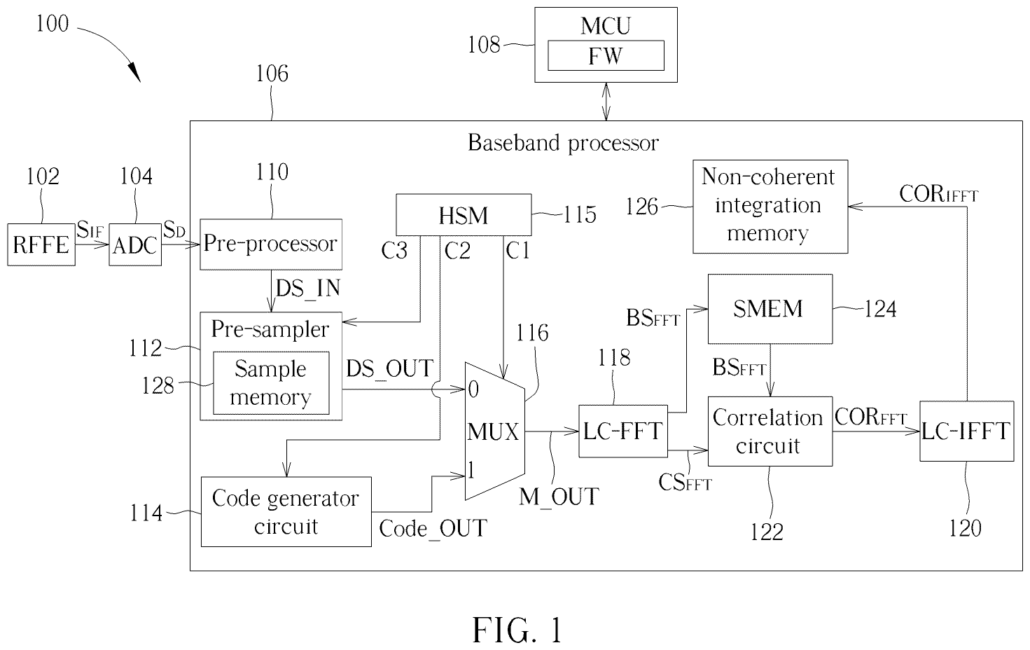

The present invention proposes a GNSS receiver which is capable of directly acquiring high complexity GNSS signals, such as Global Positioning System (GPS) L5, BeiDou B2a/b, Galileo E5a/b, E6, and Quasi-Zenith Satellite System (QZSS) L6. FIG. 1 is a diagram illustrating a GNSS receiver system-on-chip (SoC) according to an embodiment of the present invention. The GNSS receiver SoC 100 includes a radio frequency front-end (RFFE) 102, an analog-to-digital converter (ADC) 104, a baseband processor 106, and a microcontroller unit (MCU) 108. In this embodiment, the baseband processor 106 includes a pre-processor circuit (labeled by “Pre-processor”) 110, a pre-sampler circuit (labeled by “Pre-sampler”) 112, a code generator circuit 114, a hypothesis scheduling machine (HSM) 115, a multiplexer circuit (labeled by “MUX”) 116, a low-complexity fast Fourier transform (FFT) circuit (labeled by “LC-FFT”) 118, a low-complexity inverse fast Fourier transform (IFFT) circuit (labeled by “LC-IFFT”) 120, a correlation circuit 122, a spectrum memory (labeled by “SMEM”) 124, and a non-coherent integration memory 126.

The RF front-end 102 includes all components that are required to downconvert a satellite signal (which is an original RF signal received from an antenna) into a low intermediate frequency (low-IF) signal S_{IF}. For example, the RF front-end 102 may include an RF filter, an RF amplifier, a mixer, and a local oscillator. The ADC 104 is arranged to perform analog-to-digital conversion upon the analog low-IF signal S_{IF}, and generate and output an ADC output signal S_{D}.

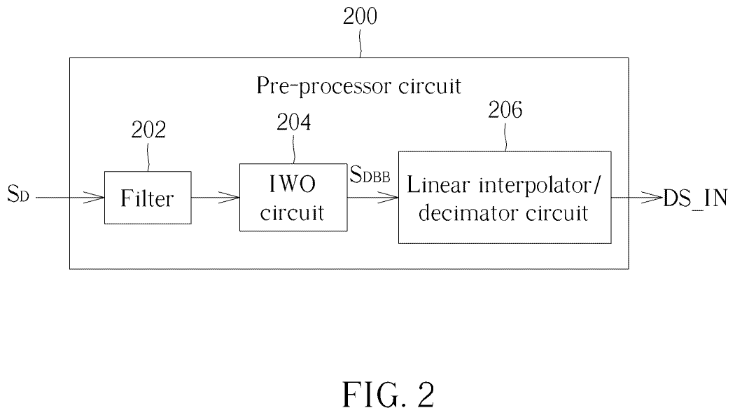

The pre-processor circuit 110 is arranged to receive the ADC output signal S_{D} (which is in the low-IF band), and perform a resampling operation upon the ADC output signal S_{D} to generate and output a data sequence input DS_IN (which is in the baseband). For example, a sampling rate (i.e., number of samples per second) of the data sequence input DS_IN is lower than a sampling rate (i.e., number of samples per second) of the ADC output signal S_{D}. FIG. 2 is a diagram illustrating a pre-processor circuit according to an embodiment of the present invention. The pre-processor circuit 110 shown in FIG. 1 may be implemented using the pre-processor circuit 200 shown in FIG. 2. The pre-processor circuit 200 includes a filter 202, an IF wipe off (IWO) circuit 204, and a linear interpolator/decimator circuit 206. The filter 202 and the IWO circuit 204 are used to apply signal processing to the ADC output signal S_{D}, for generating a digital baseband signal S_{DBB}. The linear interpolator/decimator circuit 206 includes a linear interpolator and/or a linear decimator, and is used to perform sampling rate conversion upon the digital baseband signal S_{DBB} with a higher sampling rate for generating the data sequence input DS_IN with a lower sampling rate that meets the requirements of the following digital signal processing stage (e.g., pre-sampler circuit 112). For example, the sampling rate of the ADC output signal S_{D} is 85 megahertz (MHz), and the sampling rate of the data sequence input DS_IN is 20 MHz. However, this is for illustrative purposes only, and is not meant to be a limitation of the present invention.

The pre-sampler circuit 112 includes a sample memory 128. The pre-sampler circuit 112 is arranged to receive the data sequence input DS_IN, and store data samples of the data sequence input DS_IN into the sample memory 128 in a sample-by-sample manner. In addition, the pre-sampler circuit 112 is further arranged to generate and output a data sequence output DS_OUT according to data samples stored in the sample memory 128. In this embodiment, a maximum number of data samples stored in the sample memory 128 is larger than a number of samples of a local replica generated from the code generator circuit 114 in one unit correlation time (e.g., 1 millisecond (ms)). For example, the correlation is performed upon one 1-ms local replica and one 1-ms data sequence in one unit correlation time, to generate one correlation result. The size of the sample memory 128 is large enough to accommodate 2-ms data samples. In this way, 2-ms data samples stored in the sample memory 128 can support multiple data interleaving correlation (4 times) with the same local replica, which achieves maximum utilization rate of input data, higher throughput efficiency, and lower power consumption.

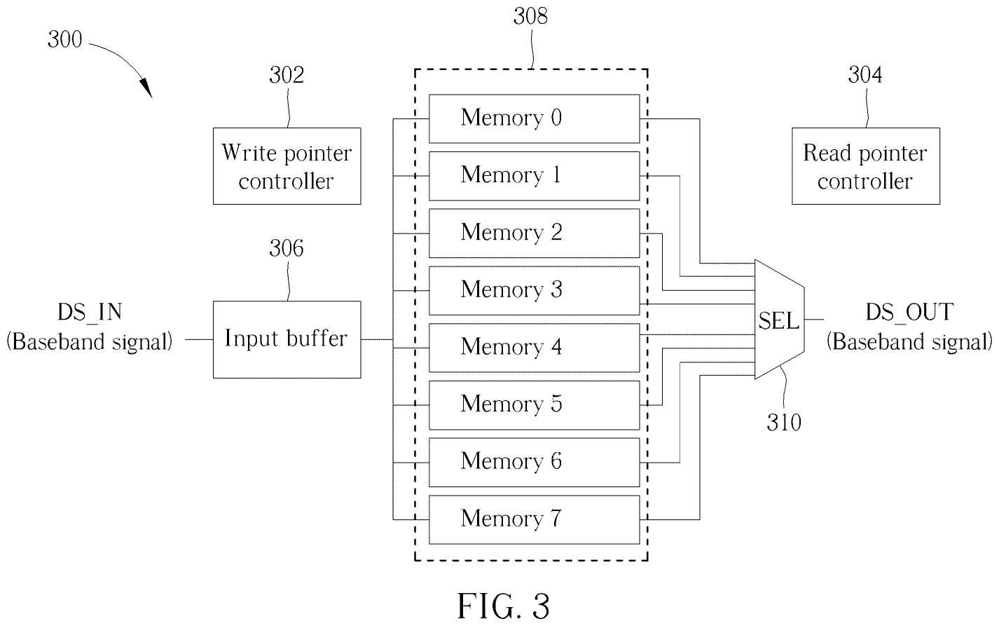

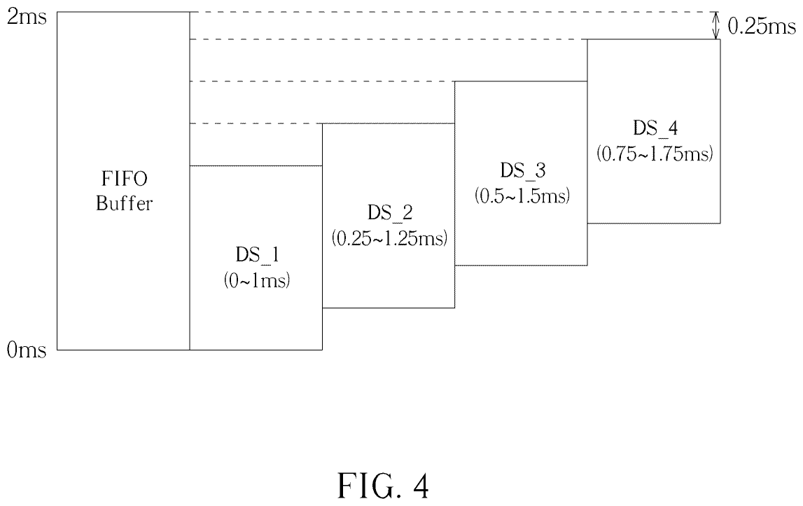

FIG. 3 is a diagram illustrating a pre-sampler circuit according to an embodiment of the present invention. The pre-sampler circuit 112 shown in FIG. 1 may be implemented using the pre-sampler circuit 300 shown in FIG. 3. The pre-sampler circuit 300 includes a write pointer controller 302, a read pointer controller 304, an input buffer 306, a sample memory 308, and a selector (SEL) 310. In this embodiment, the sample memory 308 may be a first-in first-out (FIFO) buffer that is capable of storing 2-ms data samples (i.e., data samples within a 2-ms interval) and includes a plurality of memory blocks (labeled by “Memory 0”, “Memory 1”, “Memory 2”, “Memory 3”, “Memory 4”, “Memory 5”, “Memory 6”, “Memory 7”), each used for buffering 0.25 ms data samples. The input buffer 306 is arranged to receive data samples of the data sequence input DS_IN in a sample-by-sample manner. The write pointer controller 302 controls sequential writing of 0.25 ms data samples in each of the memory blocks. The read pointer controller 304 controls reading of 1-ms data samples from 4 memory blocks in the sample memory 308. In this embodiment, the sample memory 308 allows 4 data interleaving modes with offsets 0-ms, 0.25-ms, 0.5-ms, and 0.75-ms, as illustrated in FIG. 4. The extra 0.25-ms data samples are reserved to prevent data corruption due to racing of read and write. For example, the offsets may be selected one by one. When the offset 0-ms is selected, a 1-ms data sequence DS_1 is read from the FIFO buffer (i.e., sample memory 308) as part of the data sequence output DS_OUT. When the offset 0.25-ms is selected, a next 1-ms data sequence DS_2 is read from the FIFO buffer (i.e., sample memory 308) as part of the data sequence output DS_OUT. When the offset 0.5-ms is selected, a next 1-ms data sequence DS_3 is read from the FIFO buffer (i.e., sample memory 308) as part of the data sequence output DS_OUT. When the offset 0.75-ms is selected, a next 1-ms data sequence DS_4 is read from the FIFO buffer (i.e., sample memory 308) as part of the data sequence output DS_OUT. As shown in FIG. 4, consecutive data sequences DS_1 and DS_2 have overlapping data samples read from same memory locations (e.g., same memory blocks) in the FIFO buffer (i.e., sample memory 308), consecutive data sequences DS_2 and DS_3 have overlapping data samples read from same memory locations (e.g., same memory blocks) in the FIFO buffer (i.e., sample memory 308), and consecutive data sequences DS_3 and DS_4 have overlapping data samples read from same memory locations (e.g., same memory blocks) in the FIFO buffer (i.e., sample memory 308).

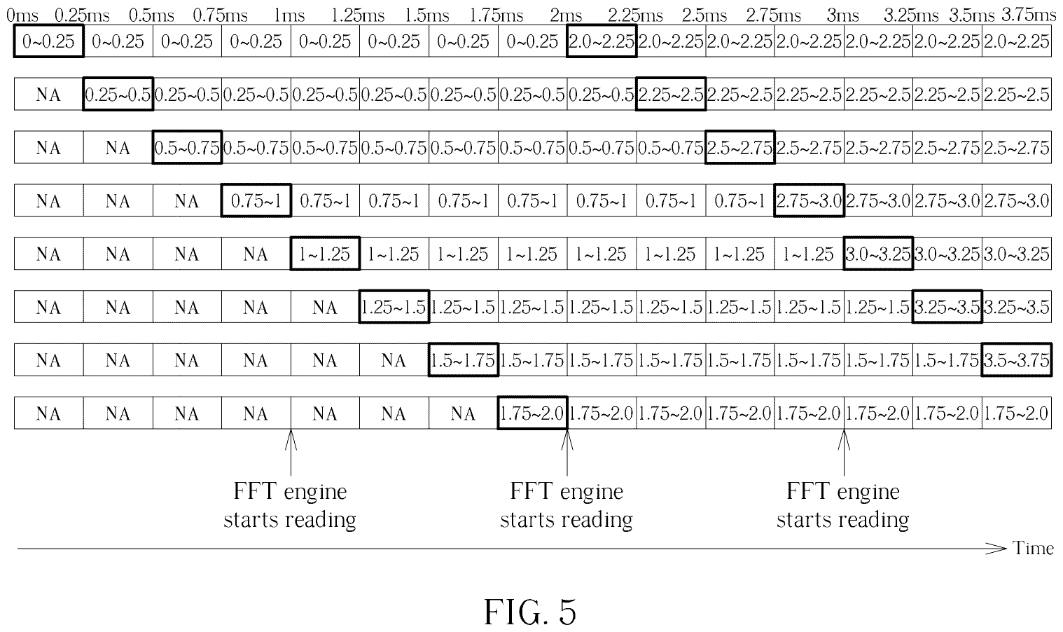

FIG. 5 is a diagram illustrating a data flow that is based on 4 data interleaving modes according to an embodiment of the present invention. Each region marked by thick lines indicates that the baseband signal is being written into one of the memory blocks allocated in the sample memory 308. After 1-ms data samples are available in the sample memory 308, the 1-ms data samples can be read from the sample memory 308 to serve as part of the data sequence output DS_OUT for following signal processing (e.g., FFT).

The code generator circuit 114 is arranged to generate and output a local replica output Code_OUT that may include samples of a plurality of PRN codes. Doppler shift of the satellite signal is caused by the relative motion of the GNSS receiver and the GNSS satellite. Hence, the GNSS baseband received signal suffers the Doppler effect, including code Doppler and carrier Doppler. The GNSS receiver SoC 100 is equipped with the capability of dealing with the Doppler effect for acquisition performance improvement. For example, the code generator circuit 114 may be implemented by a code generator circuit with code Doppler compensation and carrier Doppler compensation. Hence, the code Doppler compensation and the carrier Doppler compensation may be jointly achieved by the local replica output Code_OUT generated from the code generator circuit 114. In other words, when generating the local replica output Code_OUT, the code generator circuit 114 is capable of performing code Doppler compensation and carrier Doppler compensation at the same time. Hence, code Doppler compensation and carrier Doppler compensation are jointly considered for setting the final local replica output Code_OUT.

As shown in FIG. 1, the GNSS receiver SoC 100 has only a single pair of LC-FFT circuit 118 and LC-IFFT circuit 120. The LC-FFT circuit 118 and the LC-IFFT circuit 120 are implemented using separate circuits for better signal processing performance. There are numerous FFT and IFFT algorithms for realizing real-time application. For example, the LC-FFT circuit 118 and LC-IFFT circuit 120 may employ a variable input length, high radix 2⁴, and pipelined single-delay-feedback to conduct frequency-domain signal processing. For example, the LC-FFT circuit 118 may include a plurality of N2-point decimation in frequency (DIF) FFT circuits and a subsequent N1-point DIF FFT circuit; and the LC-IFFT circuit 120 may include an N1-point decimation in time (DIT) IFFT circuit and a plurality of subsequent N2-point DIT IFFT circuits. Moreover, the data flow and twiddle factor optimization can further reduce/omit extra data memory. In some embodiments of the present invention, the LC-FFT circuit 118 has no index mapping logic and input memory, and the LC-IFFT circuit 120 has no index mapping logic and output memory. In addition, the coefficient data memory may be minimized, and the non-trivial computation complexity may be minimized.

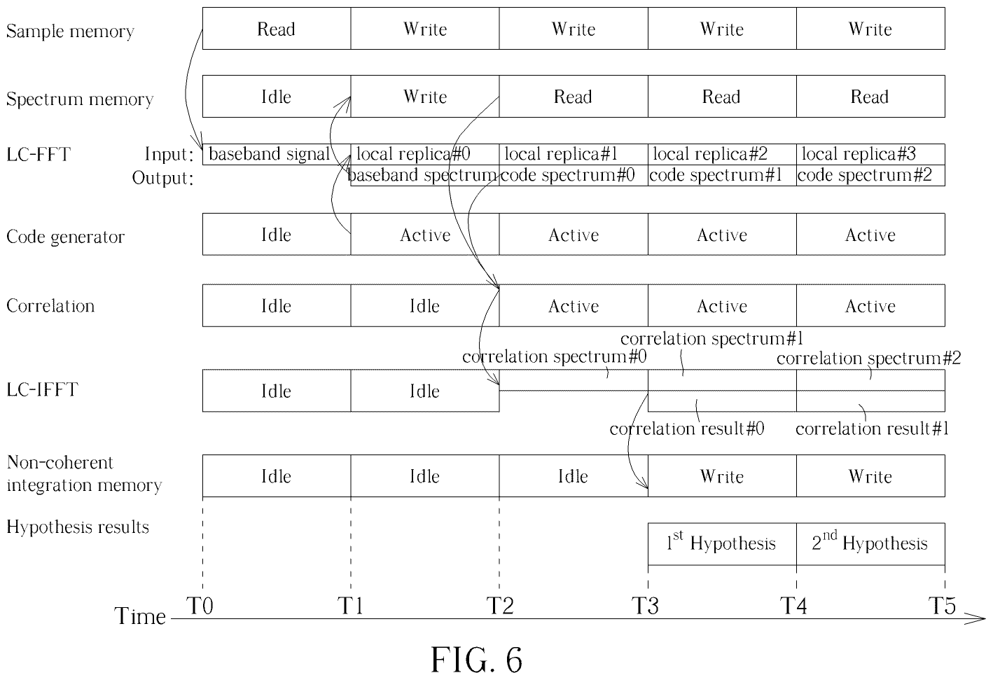

Since the GNSS receiver SoC 100 has only a single pair of LC-FFT circuit 118 and LC-IFFT circuit 120, a hardware sharing technique is employed by the GNSS receiver SoC 100. FIG. 6 is a diagram illustrating real-time signal processing performed at the GNSS receiver SoC 100 according to an embodiment of the present invention. The HSM 115 has low power consumption, low area cost, and real time adjustment. One pair of LC-FFT circuit 118 and LC-IFFT circuit 120 can have maximum hardware component sharing to complete millisecond-level of real-time signal processing. Further details of the hardware sharing technique are described as below.

The multiplexer circuit 116 has a first input port (labeled by “0”), a second input port (labeled by “1”), and an output port. The LC-FFT circuit 118 is coupled to the output port of the multiplexer circuit 116, and arranged to receive a multiplexing output M_OUT. The pre-sampler circuit 112 generates and outputs the data sequence output DS_OUT to the first input port of the multiplexer circuit 116. The code generator circuit 114 generates and outputs the local replica output Code_OUT to the second input port of the multiplexer circuit 116. The HSM 115 is coupled to the multiplexer circuit 116, the pre-sampler circuit 112, and the code generator circuit 114. Under coordination of the HSM 115, the LC-FFT circuit 118 is shared between the pre-sampler circuit 112 and the code generator circuit 114 through the multiplexer circuit 116. Specifically, the HSM 115 generates and outputs a control signal C1 to the multiplexer circuit 116, generates and outputs a control signal C2 to the code generator circuit 114, and generates and outputs a control signal C3 to the pre-sampler circuit 112. The control signal C2 may indicate the timing when the code generator circuit 114 should output the local replica output Code_OUT. The control signal C3 may indicate the timing when the code generator circuit 114 should output the data sequence output DS_OUT. The control signal C1 may act as a selection control signal. For example, the multiplexer circuit 116 couples the output port to the first input port in response to C1=0, and couples the output port to the second input port in response to C1=1. After the multiplexer circuit 116 is controlled by C1=0 to output one baseband input (which is provided by the pre-sampler circuit 112) to the LC-FFT circuit 118 during one period (e.g., T0-T1 in FIG. 6), the HSM 115 may set C1=1 during multiple subsequent periods (e.g., T1-T2, T2-T3, T3-T4, and T4-T5 in FIG. 6), thereby allowing the same baseband input to be correlated with multiple code sequences for acquisition. After the same baseband input is correlated with multiple code sequences, the non-coherent integration memory 126 may store a plurality of hypothesis results, each derived from one correlation computation in one unit correlation time.

During a period T0-T1 in FIG. 6, the HSM 115 is arranged to set C1=0, and the LC-FFT circuit 118 is arranged to receive one data sequence output M_OUT=DS_OUT (labeled by “baseband signal”) from the sample memory 128 of the pre-sampler circuit 112.

During a next period T1-T2 in FIG. 6, the HSM 115 is arranged to set C1=1; and the LC-FFT circuit 118 is arranged to generate one baseband spectrum output BS_{FFT} (labeled by “baseband spectrum”) according to the data sequence output DS_OUT (labeled by “baseband signal”) received during the previous period T0-T1, write the baseband spectrum output BS_{FFT} (labeled by “baseband spectrum”) into the spectrum memory 124 for later use, and receive one local replica output M_OUT=Code_OUT (labeled by “local replica #0”) from the code generator circuit 114.

During a next period T2-T3 in FIG. 6, the HSM 115 is arranged to set C1=1; the LC-FFT circuit 118 is arranged to generate one code spectrum output CS_{FFT} (labeled by “code spectrum #0”) according to the local replica output Code_OUT (labeled by “local replica #0”) received during the previous period T1-T2, and receive a next local replica output M_OUT=Code_OUT (labeled by “local replica #1”) from the code generator circuit 114; and the correlation circuit 122 is arranged to read the baseband spectrum output BS_{FFT} (labeled by “baseband spectrum”) from the spectrum memory 124, and perform correlation upon the baseband spectrum output BS_{FFT} (labeled by “baseband spectrum”) and the code spectrum output CS_{FFT} (labeled by “code spectrum #0”) to generate one correlation spectrum output COR_{FFT} (labeled by “correlation spectrum #0”).

During a next period T3-T4 in FIG. 6, the HSM 115 is arranged to set C1=1; the LC-FFT circuit 118 is arranged to generate one code spectrum output CS_{FFT} (labeled by “code spectrum #1”) according to the local replica output Code_OUT (labeled by “local replica #1”) received during the previous period T2-T3, and receive a next local replica output M_OUT=Code_OUT (labeled by “local replica #2”) from the code generator circuit 114; the correlation circuit 122 is arranged to read the same baseband spectrum output BS_{FFT} (labeled by “baseband spectrum”) from the spectrum memory 124, and perform correlation upon the baseband spectrum output BS_{FFT} (labeled by “baseband spectrum”) and the code spectrum output CS_{FFT} (labeled by “code spectrum #1”) to generate one correlation spectrum output COR_{FFT} (labeled by “correlation spectrum #1”); and the LC-IFFT circuit 120 is arranged to convert the correlation spectrum output COR_{FFT} (labeled by “correlation spectrum #0”) output by the correlation circuit 122 into one correlation result COR_{IFFT} (labeled by “correlation result #0”), and store the correlation result COR_{IFFT} (labeled by “correlation result #0”) into the non-coherent integration memory 126 to act as the first hypothesis result for further processing.

During a next period T4-T5 in FIG. 6, the HSM 115 is arranged to set C1=1; the LC-FFT circuit 118 is arranged to generate one code spectrum output CS_{FFT} (labeled by “code spectrum #2”) according to the local replica output Code_OUT (labeled by “local replica #2”) received during the previous period T3-T4, and receive a next local replica output M_OUT=Code_OUT (labeled by “local replica #3”) from the code generator circuit 114; the correlation circuit 122 is arranged to read the same baseband spectrum output BS_{FFT} (labeled by “baseband spectrum”) from the spectrum memory 124, and perform correlation upon the baseband spectrum output BS_{FFT} (labeled by “baseband spectrum”) and the code spectrum output CS_{FFT} (labeled by “code spectrum #2”) to generate one correlation spectrum output COR_{FFT} (labeled by “correlation spectrum #2”); and the LC-IFFT circuit 120 is arranged to convert the correlation spectrum output COR_{FFT} (labeled by “correlation spectrum #1”) output by the correlation circuit 122 into one correlation result COR_{IFFT} (labeled by “correlation result #1”), and store the correlation result COR_{IFFT} (labeled by “correlation result #1”) into the non-coherent integration memory 126 to act as the second hypothesis result for further processing.

The MCU 108 provides baseband signal processing. For example, in accordance with the sensitive requirement, the MCU 108 may perform non-coherent summation/integration upon the correlation result COR_{IFFT}. Specifically, the correlation result COR_{IFFT} may include a plurality of correlation values, each generated per unit correlation time (e.g., 1 ms), and the MCU 108 may perform the non-coherent summation/integration function to accumulate the plurality of correlation values. However, this is for illustrative purposes only, and is not meant to be a limitation of the present invention. For example, the post-correlation integration performed by the MCU 108 may be coherent integration.

In this embodiment, the MCU 108 is arranged to control receiver acquisition and tracking through firmware FW of the MCU 108. Specifically, operation configurations of hardware blocks of the baseband processor 106 can be adaptively adjusted by the firmware FW running on the MCU 108 in a real-time manner. In this way, the GNSS receiver SoC 100 has flexibility to gain performance-scalability and power-efficiency during acquisition/tracking of high complexity GNSS signals. For example, with the help of hardware and firmware co-design, the firmware FW running on the MCU 108 adaptively adjusts hypothesis scheduling configuration of the HSM 115 in real time. Hence, the number of satellite vehicles (SVs) to be acquired/tracked and/or the number of channels (e.g., lower-band data channel, lower-band pilot channel, upper-band data channel, and upper-band pilot channel) to be acquired/tracked may be adaptively adjusted according to different scenarios. In some embodiments of the present invention, the operating frequency of the correlation circuit 122 may also be adaptively adjusted according to different scenarios.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A global navigation satellite system (GNSS) receiver comprising:
a multiplexer circuit, having a first input port, a second input port, and an output port;
a fast Fourier transform (FFT) circuit, coupled to the output port;
a pre-sampler circuit, arranged to generate and output a data sequence output to the first input port of the multiplexer circuit;
a code generator circuit, arranged to generate and output a local replica output to the second input port of the multiplexer circuit; and
a hypothesis scheduling machine (HSM), coupled to the multiplexer circuit, the pre-sampler circuit, and the code generator circuit, wherein under coordination of the HSM, the FFT circuit is shared between the pre-sampler circuit and the code generator circuit through the multiplexer circuit.

2. The GNSS receiver of claim 1, wherein the FFT circuit is arranged to generate a baseband spectrum output according to the data sequence output, and generate a code spectrum output according to the local replica output; and the GNSS receiver further comprises:
a spectrum memory, arranged to store the baseband spectrum output from the FFT circuit; and
a correlation circuit, arranged to receive the code spectrum output from the FFT circuit and the baseband spectrum output from the spectrum memory, and perform correlation upon the baseband spectrum output and the code spectrum output to generate a correlation spectrum output.

3. The GNSS receiver of claim 2, further comprising:
an inverse fast Fourier transform (IFFT) circuit, arranged to convert the correlation spectrum output into a correlation result, wherein the IFFT circuit and the FFT circuit are separate circuits.

4. The GNSS receiver of claim 3, wherein the FFT circuit has no index mapping logic and input memory, and the IFFT circuit has no index mapping logic and output memory.

5. The GNSS receiver of claim 1, further comprising:
a pre-processor circuit, arranged to receive an analog-to-digital converter (ADC) output signal, and perform a resampling operation upon the ADC output signal to generate and output a data sequence input to the pre-sampler circuit, wherein the data sequence input is in a baseband.

6. The GNSS receiver of claim 5, wherein a sampling rate of the data sequence input is lower than a sampling rate of the ADC output signal.

7. The GNSS receiver of claim 5, wherein the pre-sampler circuit comprises a sample memory; the pre-sampler circuit is further arranged to receive a data sequence input and store data samples of the data sequence input into the sample memory in a sample-by-sample manner; and a maximum number of data samples stored in the sample memory is larger than a number of samples of a local replica generated from the code generator circuit in one unit correlation time.

8. The GNSS receiver of claim 7, wherein the data sequence output comprises a first data sequence and a second data sequence following the first data sequence, and the first data sequence and the second data sequence comprise overlapping data samples read from same memory locations in the sample memory.

9. The GNSS receiver of claim 1, wherein the code generator circuit is a code generator circuit with code Doppler compensation and carrier Doppler compensation, and the code Doppler compensation and the carrier Doppler compensation are jointly achieved by the local replica output generated from the code generator circuit.

10. The GNSS receiver of claim 1, further comprising:
a microcontroller unit (MCU), arranged to control receiver acquisition and tracking through firmware of the MCU;
wherein the firmware running on the MCU adaptively adjusts hypothesis scheduling configuration of the HSM in real time.

11. A global navigation satellite system (GNSS) receiving method comprising:
performing a multiplexing operation upon a data sequence output of a pre-sampling operation and a local replica output of a code generation operation, to generate a multiplexing output; and
performing fast Fourier transform (FFT) upon the multiplexing output.

12. The GNSS receiving method of claim 11, wherein the FFT generates a baseband spectrum output according to the data sequence output, and generates a code spectrum output according to the local replica output; and the GNSS receiving method further comprises:
storing the baseband spectrum output into a spectrum memory; and
performing a correlation operation upon the code spectrum output generated from the FFT and the baseband spectrum output read from the spectrum memory, to generate a correlation spectrum output.

13. The GNSS receiving method of claim 12, further comprising:
performing inverse fast Fourier transform (IFFT) to convert the correlation spectrum output into a correlation result, wherein the FFT and the IFFT are performed using separate circuits.

14. The GNSS receiving method of claim 13, wherein the FFT requires no index mapping logic and input memory, and the IFFT requires no index mapping logic and output memory.

15. The GNSS receiving method of claim 11, further comprising:
receiving an analog-to-digital converter (ADC) output signal; and
performing a resampling operation upon the ADC output signal to generate and output a data sequence input to the pre-sampling operation, wherein the data sequence input is in a baseband.

16. The GNSS receiving method of claim 15, wherein a sampling rate of the data sequence input is lower than a sampling rate of the ADC output signal.

17. The GNSS receiving method of claim 15, wherein the pre-sampling operation comprises:
receiving a data sequence input; and
storing data samples of the data sequence input into a sample memory in a sample-by-sample manner, wherein a maximum number of data samples stored in the sample memory is larger than a number of samples of a local replica generated from the code generation operation in one unit correlation time.

18. The GNSS receiving method of claim 17, wherein the data sequence output comprises a first data sequence and a second data sequence following the first data sequence, and the first data sequence and the second data sequence comprise overlapping data samples read from same memory locations in the sample memory.

19. The GNSS receiving method of claim 11, wherein code Doppler compensation and carrier Doppler compensation are jointly achieved by the local replica output generated from the code generation operation.

20. The GNSS receiving method of claim 11, further comprising:
controlling receiver acquisition and tracking through firmware of a microcontroller unit (MCU);
wherein the multiplexing operation, the pre-sampling operation, and the code generation operation are controlled by a hypothesis scheduling machine (HSM), and the firmware running on the MCU adaptively adjusts hypothesis scheduling configuration of the HSM in real time.
